(19) United States
(12) Patent Application Publication
(10) Pub. No.: US 2005/0214170 A1
(43) Pub. Date: Sep. 29, 2005

(54) Gas sensor and process for producing a gas sensor

(75) Inventor: Stefan Kading, Zerrenthin (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/806,314

(22) Filed: Mar. 23, 2004

(51) Int. Cl. G01N 27/26

(52) U.S. Cl. 422/88; 420/98

(57) ABSTRACT

The present invention relates to a gas sensor for determining the concentration of a gas component of a measurement gas and especially of a measurement gas formed by a combustion or reforming process. The gas sensor includes a layer structure and comprises a reference electrode and a catalytically active working electrode for exposure to the measurement gas. The reference electrode is completely surrounded by a gastight material.

### BACKGROUND OF THE INVENTION

1. Field of the Invention

The invention relates to a gas sensor, and a process for producing a gas sensor, for determination of the concentration of a gas component of a measurement gas, especially of a measurement gas which is formed by a combustion or reforming process, wherein the gas sensor includes a layer structure and comprising a reference electrode and a catalytically active working electrode which is to be exposed to the measurement gas.

2. Description of Related Art

Generic gas sensors can be used for example in conjunction with control of combustion processes of internal combustion engines or auxiliary motor vehicle heating systems. Furthermore, the generic gas sensor can be used in all applications for reforming of hydrocarbons, for example in conjunction with so-called reforms which convert fuel and air into a reformate, by which using a fuel cell, electrical energy can be obtained. The latter application is growing in importance especially in conjunction with so-called APUs (auxiliary power units).

A generic gas sensor is known for example from German patent application 198 24 316 A1. This publication relates to a gas sensor for determination of reducing gases in gas mixtures, especially of HC and/or CO in the exhaust gases of λ-regulated combustion plants, with a layer structure which contains an electrochemical solid chain in the form of a potentiometric and/or an amperometric measurement element with a pump cell. For the gas sensor, therefore, a layer structure is chosen having a layer of oxygen-storing material which at λ<1 releases oxygen to the measurement cell, and at λ>1 absorbs oxygen for storage. The gas sensor described in German patent application 198 24 316 A1 makes it possible either to make do with pump cells of low pump output or, when a pump cell is completely abandoned, to precisely measure the reducing gases, even in the range of the stoichiometric air/fuel ratio λ, at low cost. In this case, λ can be between 0.9 and 1.6.

Generic gas sensors ordinarily work with an air reference electrode or have an integrated air chamber; this complicates mounting and dismounting of the gas sensor and thus makes it expensive. Furthermore the measurement range of λ for generic gas sensors is generally limited to 0.9 to 2; λ measurements are not possible in the range below 0.7, as a rule. The use of generic gas sensors in reformer gases is not possible either, or only conditionally so. When the measurement is taken amperometrically, its evaluation is complex.

### SUMMARY OF THE INVENTION

The object of the invention is to provide a gas sensor wherein both the mounting and dismounting are simplified, preferably with a simultaneous enlargement of the possible measurement range relative to conventional gas sensors.

These objects, and other objects, are achieved by providing a gas sensor for determining the concentration of a gas component of a measurement gas, comprising: a layer structure including a reference electrode completely surrounded by a gastight material and a catalytically active working electrode which is to be exposed to the measurement gas. With the gas sensor of the present invention it is possible to determine the oxygen concentration in a measurement gas without the need to expose the reference electrode to air. Furthermore it is possible to detect the air/fuel ratio as the working temperature of the gas sensor of the invention allows in-situ measurement in the synthesis gases and in the exhaust gases of internal combustion engines or auxiliary heaters.

One preferred embodiment of the gas sensor of the present invention includes the gastight material, at least in sections, being formed by a solid electrolyte to which both the reference electrode and also the working electrode are connected. Embodiments are possible both in which the reference electrode and the working electrode are on the same side of the solid electrolyte, and also embodiments in which the reference electrode and the working electrode are made on different sides of the solid electrolyte.

In the above explained connection furthermore the solid electrolyte is preferably formed by an oxide ion-conducting material, especially by yttrium-stabilized zirconium dioxide.

At least in certain embodiments of the gas sensor of the present invention, the gastight material is formed at least in sections by a cover layer, especially a low-sodium glass layer. For example, both the reference electrode and also the working electrode can be made on the surface of the solid electrolyte next to one another, but spaced apart from one another, and then the reference electrode can be covered with a layer of low-sodium glass.

Furthermore, embodiments of the gas sensor of the present invention are possible in which the gastight material is formed at least in sections by a carrier material, especially an electrically insulating carrier material. This approach is possible, for example, when, first, only the reference electrode is formed on the carrier material and then is coated by the solid electrolyte layer on which then the working electrode is made.

In many applications of the gas sensor of the present invention, the gas sensor preferably includes a heating system. The heating system can be, for example, applied to the side of the electrically insulating carrier material, opposite the electrodes. In this way, it is possible to effectively prevent any unwanted influence of the applied heating voltage on the electrode potentials.

In preferred embodiments of the gas sensor of the present invention, the reference electrode has at least one material component which is chosen from the following group: metals, metal oxides, and mixtures thereof.

Furthermore it is preferred that the working electrode has at least one material component which is chosen from the following group: precious metals, precious metal alloys, oxides, oxide mixtures and mixtures thereof.

One especially preferred embodiment of the gas sensor of the claimed invention calls for it to work according to the potentiometric measurement principle. In the potentiometric measurement principle, only the voltage need be measured so that both the measurement and also its evaluation can be easily done.

In preferred embodiments of the gas sensor of the invention, the gas sensor is designed for measurement of λ values which are below 0.9, preferably below 0.6 and more preferably below 0.4. One advantage of the gas sensor of the present invention is the possibility of varying the measurement range of λ by changing the catalytic activity of the working electrode with respect to oxidation of the combustible gases.

The first embodiment of the process of the invention is characterized by the following steps: providing a carrier layer of electrically insulating material, applying a solid electrolyte layer to the carrier layer, forming a reference electrode and a working electrode on the solid electrolyte layer, and covering the reference electrode with a gastight cover layer.

A second embodiment of the process of the present invention is characterized by the following steps: providing a carrier layer of electrically insulating material, forming a reference electrode on the carrier layer, covering the reference electrode with a gastight solid electrolyte layer, and forming a working electrode on the gastight solid electrolyte layer.

The processes of the present invention can be carried out by using different production techniques, for example screen printing and/or sputtering techniques. The processes of the invention yield a gas sensor which has the aforementioned advantages. The same applies in a general sense to the advantageous developments of the processes of the present invention detailed below, reference also being made in this respect to the corresponding statements in conjunction with the explanation of the gas sensor of the invention.

One preferred development of the process of the invention calls for electrically conductive connections to be formed to the reference electrode and the working electrode.

Furthermore, it is also preferred in this connection that the solid electrolyte layer is formed by an oxide ion-conducting material, especially by yttrium-stabilized zirconium dioxide. If provided, it is preferred that the cover layer is a low-sodium glass layer.

As another step of the processes of the invention, the following can be provided: formation of an electrical heating system on the side of the carrier layer facing away from the reference electrode and the working electrode. In conjunction with the process of the invention, it is also preferred that, for the reference electrode, at least one material component be used which is chosen from the following group: metals, metal oxides and mixtures thereof. Furthermore it is considered advantageous that, for the working electrode, at least one material component be used which is chosen from the following group: precious metals, precious metal alloys, oxides, oxide mixtures, and mixtures thereof.

The processes of the invention can furthermore advantageously comprise the following step: choosing the catalytic activity of the working electrode such that the gas sensor is suitable for measurement of λ values below 0.9, preferably below 0.6 and more preferably below 0.4.

### BRIEF DESCRIPTION OF THE DRAWINGS

FIG. 1 shows a section of a first embodiment of the gas sensor of the present invention and illustrates a first embodiment of the process of the invention, and

FIG. 2 shows a section of a second embodiment of the gas sensor of the present invention and illustrates a second embodiment of the process of the invention.

### DETAILED DESCRIPTION OF THE INVENTION

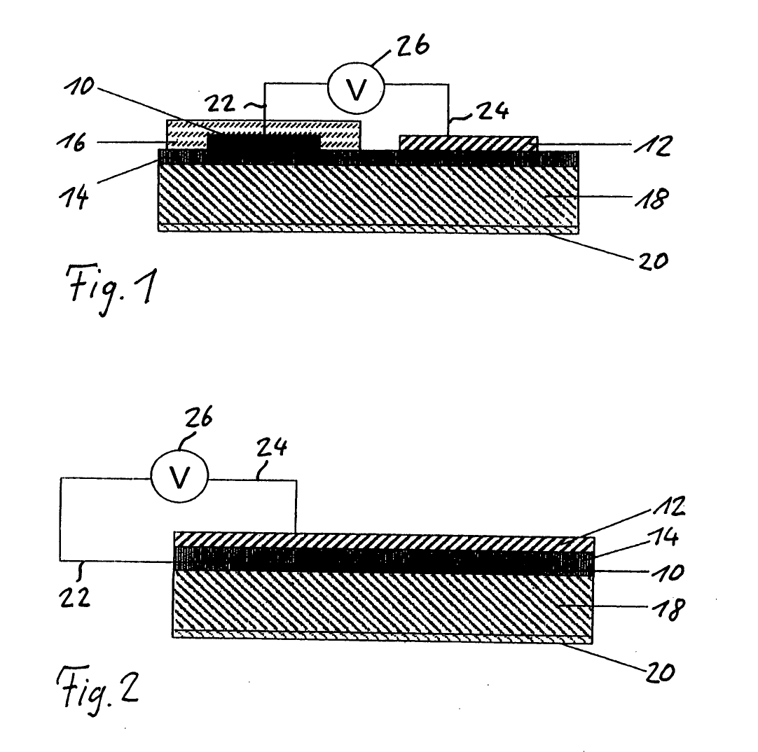

The embodiment of the gas sensor of the present invention shown in FIG. 1 can be produced as follows by a first embodiment of the process of the present invention. First there is a carrier layer 18 of electrically insulating material which can consist, for example, of a ceramic material. Then a solid electrolyte layer 14 is applied to the carrier layer 18, and the solid electrolyte layer 14 can consist of an yttrium-stabilized zirconium dioxide. A reference electrode 10 of a metal or a metal oxide is formed on the surface of the solid electrolyte layer 14. A working electrode 12 of a precious metal, a precious metal alloy, an oxide or an oxide mixture is likewise formed on the solid electrolyte layer 14. Then the reference electrode 10 is covered by a cover layer 16 of low-sodium glass. Electrical leads 22, 24 connected to the reference electrode 10 and the working electrode 12 are used to determine a potential difference using a voltmeter 26. The heating system 20 can be formed at any suitable time, especially at the start of the process.

The manner of operation of the gas sensor shown in FIG. 1 is as follows. Using the integrated heating system 20, the gas sensor is heated to the working temperature. Because the heating 20 system is applied to the electrically insulating carrier layer 18, any influence on the potentials of the reference electrode 10 and the working electrode 12 can be reliably prevented. The gastight cover layer 16 prevents contact of the reference electrode 10 and the measurement gas. As soon as the working temperature is reached, an oxygen partial pressure is established on the solid reference electrode 10, which, thermodynamically determined, is dependent only on the temperature. The working electrode 12 is exposed to the measurement gas. On this electrode, an oxygen partial pressure is established which corresponds to the composition of the measurement gas. By the electrical interconnection of the reference electrode 10 and the working electrode 12 via the solid electrolyte 14, the difference of the electrode potentials between the reference electrode 10 and the working electrode 12 can be measured as the cell voltage with the voltmeter 26. This cell voltage can be used especially to compute the oxygen concentration in the measurement gas.

For the case in which the measurement gas, besides oxygen, also contains CO, H₂ or other combustible components, the sensor structure of the present invention is suited for determining the λ value. It is determined from the oxygen concentration in the measurement gas after complete combustion of the combustible components in the exhaust gas. The combustion takes place on or in the vicinity of the working electrode 12 so that an oxygen partial pressure can be established on the working electrode 12. One advantage of the gas sensor arrangement of the invention is the possible variation of the measurement range of λ. This variation is enabled by changing the catalytic activity of the working electrode 12 with respect to the oxidation of the fuel gases. An increase of the catalytic activity leads to an enlargement of the measurement range, mainly for λ<1.

When the working electrode 12 is completely inactive with respect to the oxidation of the combustible gas components, the oxygen concentration in the gas can be determined from the cell voltage obtained.

The embodiment of the gas sensor of the invention shown in FIG. 2 can be produced as follows by a second embodiment of the process of the invention. First, a carrier layer 18 of electrically insulating material is provided which can be for example a ceramic material. Then a reference electrode 10 formed from a metal or metal oxide is formed on the carrier layer 18. The reference electrode 10 is then covered by a gastight solid electrolyte layer 14 which can also be formed in this case preferably by an yttrium-stabilized zirconium dioxide. Then a working electrode 12, which consists again of a precious metal, a precious metal alloy, an oxide or an oxide mixture, or which can at least contain these materials, is formed on the gastight solid electrolyte layer 14. In this case, there are also electrical leads 22, 24 connected to the reference electrode 10 and the working electrode 12 to be able to determine a potential difference with a voltmeter 26. The heating 20 which is provided at the bottom relative to the figure can also be provided at any suitable time in this embodiment, especially at the start of the process.

The manner of operation of the gas sensor shown in FIG. 2 is as follows. First the entire gas sensor module is brought to the working temperature with the heating system 20. As soon as the working temperature is reached, an electrode potential is established on the solid reference electrode 10, which, thermodynamically determined, is dependent only on the temperature. The gastight solid electrolyte 14 prevents admittance of the measurement gas to the reference electrode 10. The working electrode 12 is exposed to the measurement gas. On this electrode, an electrode potential is established which is influenced by the gas composition in the measurement gas. The reference electrode 10 and the working electrode 12 are again interconnected by the solid electrolyte 14, and the difference of the electrode potentials can be measured with the voltmeter 26. This equilibrium cell voltage can also be used in this case to determine the oxygen partial pressure or λ.

The invention yields the following advantages: wide λ range mainly for λ<1 (lambda measurement up to the soot limit possible); gas-symmetrical structure, i.e. the two electrodes (working and reference electrode) are located in the test gas; the variation of the catalytic activity changes the measurement range; in-situ measurement in the synthesis gas possible (λ<0.4); elimination of the air reference electrode, therefore flushing with air can be abandoned; potentiometric sensor principle; simple integration of temperature measurement possible; no cross sensitivity in λ determination under the assumption of complete combustion; simple structure; planar structure; prevention of long-term drift by using materials which are stable over the long run; heating can be abandoned when the exhaust gases are hot enough; use of different production techniques combined is possible (screen printing or sputtering technique).

The features of the invention disclosed in the specification above, in the drawings and in the claims can be important to the implementation of the invention both individually and also in any combination.

1. A gas sensor for determining the concentration of a gas component of a measurement gas, comprising:
a layer structure including a reference electrode completely surrounded by a gastight material and;
a catalytically active working electrode which is to be exposed to the measurement gas.

2. The gas sensor of claim 1, wherein the gastight material is formed at least in sections by a solid electrolyte to which both the reference electrode and the working electrode are connected.

3. The gas sensor of claim 2, wherein the solid electrolyte is formed by an oxide ion-conducting material.

4. The gas sensor of claim 3, wherein the oxide ion-conducting material is yttrium-stabilized zirconium dioxide.

5. The gas sensor of claim 1, wherein the gastight material is formed in sections by a low-sodium glass cover layer.

6. The gas sensor of claim 1, wherein the gastight material is formed in sections by an electrically insulating carrier material.

7. The gas sensor of claim 1, further including a heating system.

8. The gas sensor of claim 1, wherein the reference electrode has at least one material component which is chosen from the following group: metals, metal oxides, and mixtures thereof.

9. The gas sensor of claim 1, wherein the working electrode has at least one material component which is chosen from the following group: precious metals, precious metal alloys, oxides, oxide mixtures and mixtures thereof.

10. The gas sensor of claim 1, wherein the gas sensor operates according to a potentiometric measurement principle.

11. The gas sensor of claim 9, wherein the gas sensor is capable of measuring λ values which are below 0.9.

12. The gas sensor of claim 11, wherein the gas sensor is capable of measuring λ values below 0.6.

13. The gas sensor of claim 12, wherein the gas sensor is capable of measuring λ values below 0.4.

14. A process for producing a gas sensor used for determining the concentration of a gas component of a measurement gas, comprising the steps of:
providing a carrier layer of electrically insulating material;
applying a solid electrolyte layer to the carrier layer;
forming a reference electrode and a working electrode on the solid electrolyte layer; and
covering the reference electrode with a gastight cover layer.

15. A process for producing a gas sensor used for determining the concentration of a gas component of a measurement gas, comprising the following steps:
providing a carrier layer of electrically insulating material;
forming a reference electrode on the carrier layer;
covering the reference electrode with a gastight solid electrolyte layer; and
forming a working electrode on the gastight solid electrolyte layer.

16. The process of claim 14, wherein electrically conductive connections are formed to the reference electrode and the working electrode.

17. The process of claim 14, wherein the solid electrolyte layer is formed by an oxide ion-conducting material.

18. The process as claimed in claim 14, wherein the cover layer is a low-sodium glass layer.

19. The process of claim 14, further comprising the step of forming an electrical heating system on a side of the carrier layer facing away from the reference electrode and the working electrode.

20. The process of claim 15, wherein the reference electrode has at least one material component chosen from the following group: metals, metal oxides, and mixtures thereof.

21. The process of claim 15, wherein the working electrode has at least one material component chosen from the following group: precious metals, precious metal alloys, oxides, oxide mixtures and mixtures thereof.

22. The process of claim 14, further comprising the step of choosing a catalytic activity of the working electrode such that the gas sensor is capable of measuring λ values which are below 0.9.

23. The process of claim 22, wherein the gas sensor is capable of measuring λ values below 0.6.

24. The process of claim 23, wherein the gas sensor is capable of measuring λ values below 0.4.
